(19) United States
(12) Patent Application Publication
(10) Pub. No.: US 2021/0387182 A1
(43) Pub. Date: Dec. 16, 2021

(54) REVERSIBLE MICROFLUIDIC CHIP

(71) Applicants: CENTRE NATIONAL DE LA RECHERCHE SCIENTIFIQUE, PARIS (FR); INSTITUT NATIONAL DES SCIENCES APPLIQUEES DE TOULOUSE, TOULOUSE Cedex 4 (FR)

(72) Inventors: Simon RAFFY, TOULOUSE (FR); Laurence RESSIER, AUZEVILLE TOLOSANE (FR); Etienne PALLEAU, ESCALQUENS (FR)

(21) Appl. No.: 17/287,502

(22) PCT Filed: Oct. 23, 2019
(86) PCT No.: PCT/FR2019/052530

§ 371 Date: Apr. 21, 2021

(30) Foreign Application Priority Data
Oct. 26, 2018 (FR) 1859900

(51) Int. Cl. B01L 3/00; B29C 39/36; B29C 39/02; B29C 33/40; B29C 33/38; B29C 39/00; B32B 27/08; B32B 27/38

(52) U.S. Cl. CPC B01L 3/502707; B29C 39/36; B29C 39/025; B29C 33/405; B29C 33/3857; B29C 39/006; B29L 2031/752; B32B 27/38; B01L 2200/12; B01L 2300/0887; B01L 2300/123; B01L 2300/04; B32B 27/08

(57) ABSTRACT

The invention relates to a reversible microfluidic chip comprising at least one lower part and at least one upper part configured to come into contact with said lower part and to close said chip, said lower part and/or said upper part comprising a microfluidic structure, and said upper part comprising at least one layer of a flexible epoxide polymer material and at least one layer of a rigid epoxide polymer material, at least one part of the flexible layer being directly in physical contact with the lower part of the chip when said chip is in the closed configuration, to the method for the fabrication thereof, to the use of said upper part in a reversible microfluidic chip, to said upper part for producing said chip, and to the uses of said chip in various applications.

The invention relates to a reversible microfluidic chip comprising at least one lower part and at least one upper part configured to come into contact with said lower part and to close said chip, said lower part and/or said upper part comprising a microfluidic structure, and said upper part comprising at least one layer of a flexible epoxide polymer material and at least one layer of a rigid epoxide polymer material, at least one part of the flexible layer being directly in physical contact with the lower part of the chip when said chip is in the closed configuration, to the method for the fabrication thereof, to the use of said upper part in a reversible microfluidic chip, to said upper part for producing said chip, and to the uses of said chip in various applications.

The application applies more particularly, but not exclusively, to the field of microfluidic chips that can be used to monitor reactions and/or interactions, while at the same time guaranteeing rapid opening and closing during the placing of a sample for which it is desired to monitor the reactions in real time.

Over the past few years, microfluidic chips have gradually replaced conventional systems for carrying out biological protocols (plates containing wells, tubes, Eppendorf tubes, pipettes, etc.). Microfluidic chips make it possible in particular to manipulate fluids (biological samples, reagents, solvents) in a very small volume (e.g. from 1 microlitre to 1 picolitre), which is particularly advantageous when the samples are rare and the reagents are expensive, and/or when it is desired to manipulate objects, the size of which is of the order of magnitude of a cell (e.g. manipulation of DNA strands). A microfluidic chip generally comprises a microfluidic structure containing one or more microfluidic channels or microchannels of varied geometries (shapes, sizes, etc.). The channels of the microfluidic chip are connected to one another so as to perform a desired function (mixing, reactions, pumping, sorting, control of the biochemical environment, etc.). This channel network enclosed in the microfluidic chip is connected to the exterior by inlets and outlets pierced through the chip. It is via these holes that the liquids (or gases) are injected into and discharged from the microfluidic chip (by means of tubes, connectors, syringe adapters or simple holes in the chip), with exterior active systems (pressure controller, syringe driver or peristaltic pumps) or passive means (e.g. capillary forces).

The microfluidic chips are fabricated from one or more materials (silicon, glass, polymer material) and the geometry of the channels is obtained by direct or indirect means of processes of the cleanroom type: photolithography and etching. Silicon and glass have a high temperature resistance and pressure resistance (500° C. for 300 bar) and a good chemical resistance, and make it possible to easily modulate the aspect ratios of the chip owing to their rigid structure (aspect ratio ranging up to 2000 for glass). The aspect ratio is defined as the ratio of the opening (width) of a pattern or of a channel to its depth (height). A high aspect ratio can make it possible to modify the flow profiles, to broaden the observation window, and/or to perform experimental 2D approximation. However, such materials are difficult to seal; few methods are available (chemical functionalization, local fusion, use of adhesives), and they are not reversible or cannot be used a large number of times. Consequently, when the chip has been closed and used, it cannot be used again without being damaged. Moreover, it cannot be opened and closed rapidly, in particular for introducing a sample. This represents a drawback if it is desired to control the contacting and the circulation of fluids on this sample. Furthermore, the available methods for producing the microchannels of these chips are derived from microelectronic techniques and some of them require heavy and expensive equipment. Finally, glass chips are fragile, and not very suitable for low-cost prototyping.

Polymer materials have also been proposed, such as materials polymerized by addition of a crosslinking initiator or agent (epoxy resin sold under the reference SU-8, PDMS), or thermoplastic polymer materials (polytetrafluoroethylene, polycarbonate, polystyrene). These materials have variable physicochemical properties. Unlike silicon and glass, polymer materials allow simpler and more versatile sealing of the chip. Several methods are used, such as magnetic sealing, mechanical sealing (use of clamps or screws), pneumatic sealing (suctioning of air or placing under a vacuum), the use of adhesives, chemical functionalization, etc. However, most of these methods do not withstand high pressures, creating a limited working pressure (i.e. less than a few bar), or can generate defects in terms of leaktightness.

The microfluidic chips most commonly used comprise a lower part or substrate having a planar surface (e.g. glass substrate), and an upper part made of a polymer material containing a microfluidic structure (microchannels moulded into the upper part), the upper part being capable of coming into contact with said lower part and of closing said chip. The polymer material most commonly used is PDMS, since it allows rapid prototyping, and the obtaining of numerous geometries; and it provides good compatibility with living biological systems. The fabrication of a microfluidic chip begins with the drawing of the channels on dedicated software (AUTOCAD, LEDIT, Illustrator, etc.). Once this drawing has been made, it is transferred onto an optical mask such as a glass plate covered with chromium or a polymer film. The microchannels are printed with a UV-opaque ink (if the support is a polymer film) or etched in chromium (if the support is a glass plate). A microfluidic mould is then fabricated by photolithography. During this step, the drawings representing the microchannels on the mask are converted into actual microchannels on a mould. For example, an epoxy resin (e.g. negative photosensitive resin of epoxy type sold under the trade name SU-8) is deposited on a flat support (e.g. silicon wafer) with the desired thickness (which will determine the height of the microchannels). The epoxy resin protected by the mask on which the channels are drawn is then partially exposed to UV rays. Only the parts representing the channels are exposed to the UV rays and polymerized, the other parts of the mould being protected by the opaque areas of the mask. The mould is developed in a solvent which dissolves all the areas of resin that were not exposed to the UV rays. In the case of a positive resin, it is the UV-insolated areas that are dissolved. A microfluidic mould with a resin replica of the patterns that were present on the photomask (the future microchannels are “reliefs” on the mould) is thus obtained. The microchannels fabricated in relief on the mould subsequently make it possible to obtain recessed replicas in the future material of the microfluidic chip. For example, when the future material of the chip is PDMS, a mixture of PDMS in liquid form and of crosslinking agent is poured onto the microfluidic mould as prepared above, and the whole thing can optionally be placed in an oven in order to accelerate the polymerization. Once the PDMS has solidified, it can be detached from the mould. A replica of the PDMS microchannels is then obtained. In order to enable the injection of fluids, the inlets and outlets of the microfluidic chip are pierced in the PDMS using a needle or a hole-punch of the size of the future exterior tubes or connectors. Finally, the face of the PDMS block with the microchannels and the glass substrate are plasma-treated, so as to then make it possible to bond the PDMS and the glass substrate in order to irreversibly close the microfluidic chip. However, PDMS does not withstand organic solvents (e.g. hydrocarbon-based solvents such as hexane), it can absorb small molecules, limiting the reactions tested, it deforms under high pressure or high flow rate, it does not allow the formation of microfluidic chips with high aspect ratios (e.g. greater than 20).

A microfluidic chip comprising a lower part made of PMMA, and an upper part made of epoxy resin containing a microfluidic structure, said upper part being capable of coming into contact with said lower part and of closing said chip, has been proposed in international application WO 2011/072713 A1. However, the chip is not reversible, and does not make it possible to monitor a reaction and/or to introduce a sample for which it is desired to monitor the changes. Moreover, the aspect ratio of such a chip remains low.

The objective of the present invention is therefore to overcome the abovementioned drawbacks, and to provide a reversible microfluidic chip which can open and/or close rapidly and easily, in particular in order to be able to introduce samples of any nature (e.g. sensitive reagents, reagents diluted in organic solvents); which makes it possible to visualize this sample in real time, and/or to control the contacting and the circulation of fluids on this sample, in particular for reliably measuring reaction kinetics and/or interactions; which makes it possible to work at acceptable pressures; which achieves high aspect ratios, in particular for obtaining improved analysis performance levels; and which preserves the main advantages of microfluidic chips made of polymer, that is to say the modularity and the relatively simple microfabrication.

The first subject of the invention is a reversible microfluidic chip comprising at least one lower part and at least one upper part configured to come into contact with said lower part and to close said chip, characterized in that:
said lower part and/or said upper part comprises a microfluidic structure,
said upper part comprises at least a first layer of an epoxide polymer material having a Young's modulus Y₁, and at least a second layer of an epoxide polymer material having a Young's modulus Y₂, said first and second layers being such that:
   the Y₁/Y₂ ratio is greater than or equal to 50,
   Y₂ is less than or equal to 50 MPa, and
at least one part of said second layer is directly in physical contact with the lower part of said chip when the chip is in the closed configuration.

Thus, by virtue of the first and second layers of respective Young's moduli Y₁ and Y₂ in the upper part of the microfluidic chip, with at least one part of said second layer being directly in physical contact with the lower part of said chip when the chip is in the closed configuration, a reversible microfluidic chip, that can open and close rapidly and easily, having high aspect ratios, making it possible to work at acceptable pressures (of the order of 1 bar), having good chemical resistance, in particular with respect to organic solvents generally excluded by virtue of their capacity to deform or degrade conventional PDMS chips (hydrocarbon-based solvents such as hexane), and having the ability to self-repair, is obtained. In particular, the reversibility of the chip of the invention and its ability to self-repair the area of adhesion of the upper part with the lower part make it possible to limit the costs and time associated with the design of conventional chips.

For the purposes of the invention, the expression “reversible” means that the chip can open and close several times. The chip consequently reversibly seals (and opens). In other words, the linkage between the lower and upper parts is reversible. Conversely, the prior art chips are irreversible, i.e. the linkage between the lower and upper parts is permanent. Once sealed, they can no longer open without being damaged.

The Upper Part

The First Layer

The first layer of epoxide polymer material of the upper part has a Young's modulus Y₁. This first layer represents a rigid layer, in comparison with the second layer of the upper part. This first layer makes it possible in particular to open and close the chip simply, rapidly and reversibly. In particular, the microfluidic chip of the invention can be opened and closed several times, and thus re-used at least about twenty times, and preferably at least about forty times. Moreover, the first layer of the upper part reduces the deformation of the channels and thus limits the stripping during the flows under pressure. Finally, by virtue of the first layer, it is possible to produce patterns or channels with high aspect ratios (e.g. greater than 1000), and also to form a cavity in the upper part, in particular making it possible to visualize and monitor the change in a sample that can reach the scale of a centimetre.

The first layer is such that the Y₁/Y₂ ratio is greater than or equal to approximately 50, preferably greater than or equal to approximately 100, particularly preferably greater than or equal to approximately 150, and more particularly preferably greater than or equal to approximately 200.

The first layer can be such that the Y₁/Y₂ ratio is less than or equal to approximately 2000, preferably less than or equal to approximately 1500, and particularly preferably less than or equal to approximately 1250.

In one embodiment of the invention, the Young's modulus Y₁ of the first layer is at least approximately 0.1 GPa, preferably at least 0.5 GPa, particularly preferably at least 1 GPa, and more particularly preferably at least approximately 1.5 GPa.

In the present invention, the Young's modulus is determined at ambient temperature (i.e. 20-25° C.), preferably using a device sold under the trade name Krautkramer USM 35X, by the company GE Inspection Technologies, said device comprising Krautkramer G5 KB and K4KY transducers from the company GE Inspection Technologies.

The first layer is preferably a transparent layer.

For the purposes of the invention, a transparent element or transparent layer can transmit at least one part of the incident light (or incident light ray) with very little, or no dispersion. Preferably, the light transmittance, in particular the visible light transmittance, through the transparent element or the transparent layer is at least approximately 60% (for 1 cm of sample passed through). The light transmittance is the amount of light that the transparent element or transparent layer allows to pass through from an incident light ray. The visible light transmittance is the amount of visible light, corresponding to the electromagnetic waves, the wavelength of which corresponds to the visible spectrum, that is to say between the wavelengths of approximately 380 and 780 nm, that the transparent element or the transparent layer allows to pass through from an incident light ray. In the present invention, the optical transparency is determined using a device sold under the trade name Cary 5000 UV-Vis-NIR by the company Agilent. The measurements are carried out from 175 to 800 nm.

The epoxide polymer material of the first layer can comprise at least approximately 70% by weight of epoxide polymer(s), preferably at least approximately 80% by weight of epoxide polymer(s), particularly preferably at least approximately 90% by weight of epoxide polymer(s), and more particularly preferably at least approximately 95% by weight of epoxide polymer(s).

The epoxide polymer material of the first layer can be obtained from a crosslinkable composition A comprising one or more epoxide precursors.

For the purposes of the invention, an epoxide precursor comprises one or more epoxide groups (or oxirane rings).

The crosslinkable composition A of the invention can be in the form of a mixture of monomers and/or of oligomers and/or of polymers.

The polymerization of the crosslinkable composition A makes it possible to obtain the epoxide polymer material of the first layer, and thus to form the first layer of the upper part of the chip.

The epoxide precursor of the crosslinkable composition A can be chosen from cycloaliphatic epoxy resins, polyglycidyl ether epoxy resins, polyglycidyl ester epoxy resins, composite epoxy resins obtained by copolymerization with glycidyl methacrylate, and epoxy resins obtained from unsaturated fatty acid glycerides.

The polyglycidyl ether epoxy resins are particularly preferred.

By way of preferred examples of polyglycidyl ether epoxy resins, mention may be made of the products of the condensation reaction of epichlorohydrin with polyphenols such as bisphenol A or bisphenol F, polyglycidyl ether aliphatic epoxy resins, polyglycidyl ether aromatic epoxy resins, or a mixture thereof.

The polyglycidyl ether epoxy resins are preferably diglycidyl ether epoxides.

According to one preferred embodiment, the crosslinkable composition A comprises at least a first epoxide precursor chosen from the products of the condensation reaction of epichlorohydrin with a polyphenol, preferably the products of the condensation reaction of epichlorohydrin with a polyphenol A or a polyphenol F, and particularly preferably the products of the condensation reaction of epichlorohydrin with a polyphenol A.

The first precursor can represent at least 20% by weight, preferably at least 25% by weight, and particularly preferably at least 30% by weight, relative to the total weight of the crosslinkable composition A.

The first precursor can represent at most 90% by weight, and preferably at most 80% by weight, relative to the total weight of the crosslinkable composition A.

The first precursor may be the only epoxide precursor of the crosslinkable composition A or may be combined with other epoxide precursors. The crosslinkable composition A can also comprise at least a second epoxide precursor chosen from diglycidyl ether aliphatic epoxy resins, diglycidyl ether aromatic epoxy resins, and the products of the condensation reaction of epichlorohydrin with a polyphenol, and preferably chosen from diglycidyl ether aliphatic epoxy resins, and the products of the condensation reaction of epichlorohydrin with a polyphenol.

The second precursor can represent at least 2% by weight, and preferably at least 4% by weight, relative to the total weight of the crosslinkable composition A.

The second precursor can represent at most 50% by weight, and preferably at most 45% by weight, relative to the total weight of the crosslinkable composition A.

When the crosslinkable composition A comprises a first and a second precursor chosen from the products of the condensation reaction of epichlorohydrin with a polyphenol, said first and second epoxide precursors are different. For example, the crosslinkable composition A can comprise a product of the condensation reaction of epichlorohydrin with bisphenol A, and a product of the condensation reaction of epichlorohydrin with bisphenol F.

The crosslinkable composition A can also comprise at least a third epoxide precursor chosen from monoglycidyl ether aliphatic epoxy resins, and monoglycidyl ether aromatic epoxy resins.

The third precursor can represent at least 2% by weight, and preferably at least 4% by weight, relative to the total weight of the crosslinkable composition A.

The third precursor can represent at most 80% by weight, and preferably at least 70% by weight, relative to the total weight of the crosslinkable composition A.

According to a first particularly preferred embodiment of the invention, the crosslinkable composition A comprises at least one product of the condensation reaction of epichlorohydrin with a polyphenol, at least one monoglycidyl ether aliphatic epoxy resin, and at least one diglycidyl ether aliphatic epoxy resin. By way of example of such a mixture of crosslinkable epoxide precursors, mention may be made of the mixture sold under the trade name EC161 by the company Esprit composite, comprising the product of the reaction of bisphenol A with epichlorohydrin as product of the condensation reaction of epichlorohydrin with a polyphenol; C₁₂-C₁₄ alkyl glycidyl ethers as monoglycidyl ether aliphatic epoxy resins; and 1,4-bis(2,3-epoxypropoxy)butane as diglycidyl ether aliphatic epoxy resin.

According to a second particularly preferred embodiment of the invention, the crosslinkable composition A comprises at least two different products of the condensation reaction of epichlorohydrin with a polyphenol, and at least one monoglycidyl ether aliphatic epoxy resin. By way of example of such a mixture of crosslinkable epoxide precursors, mention may be made of the mixture sold under the trade name WWAS or WWA by the company Resoltech, comprising the product of the reaction of bisphenol A with epichlorohydrin as first product of the condensation reaction of epichlorohydrin with a polyphenol; the product of the reaction of bisphenol F with epichlorohydrin as second product of the condensation reaction of epichlorohydrin with a polyphenol, and C₁₀-C₁₆ alkyl glycidyl ethers as monoglycidyl ether aliphatic epoxy resins.

In one particular embodiment, the crosslinkable composition A also comprises at least one hardener. Thus, the epoxide polymer material of the first layer can be obtained by polymerization of a crosslinkable composition A comprising at least one epoxide precursor as defined in the invention and at least one hardener, in particular by polycondensation or by polyaddition, and preferably by polyaddition.

The hardener (or crosslinking agent) can be based on at least one acid anhydride, on at least one polyamine (e.g. (cyclo)aliphatic amines, aromatic amines), on at least one polyamide, on at least one amidoamine, or on a mixture thereof.

By way of examples of acid anhydrides, mention may be made of methyltetrahydrophthalic anhydride (MTHPA), methyl nadic anhydride (MNA) or methylhexahydrophthalic anhydride (MHHPA).

By way of examples of polyamines of aliphatic or cycloaliphatic amine type, mention may be made of those comprising two primary amines such as diethylenetriamine (DETA), tetraethylenetetramine (TETA), polyetheramines (Jeffamine®), or isophorone diamine (IPDA).

By way of examples of polyamides, mention may be made of the products of the condensation of polyamines with acid dimers or fatty acid dimers.

By way of examples of amidoamines, mention may be made of the products of the reaction of carboxylic acids (derived from C₁₆-C₁₉ fatty acids) with aliphatic polyamines (TETA).

By way of examples of polyamines of aromatic amine type, mention may be made of those comprising two primary amines such as 4,4′-diaminodiphenylmethane (DDM), diaminodiphenylsulfone (DDS), methylene-bis(diisopropylaniline) (MPDA) or bis(aminochlorodiethylphenyl)methane (MCDEA).

By way of examples of polyamines of cycloaliphatic or aliphatic amine type, mention may be made of those comprising two or three primary amines such as 3-aminomethyl-3,5,5-trimethylcyclohexylamine, trimethylhexane-1,6-diamine, polyoxypropylene triamine or poly(propylene glycol)bis(2-aminopropyl ether).

According to one preferred embodiment, the hardener comprises one or more polyamines, in particular one or more diamines and/or triamines, preferably comprising primary amines.

The hardener can also comprise at least one aromatic alcohol, such as benzyl alcohol.

According to one embodiment of the invention, the hardener comprises at least one aliphatic polyamine, preferably including two or three primary amines; optionally at least one cycloaliphatic polyamine, preferably including two or three primary amines; and optionally at least one phenol.

According to one preferred embodiment of the invention, the hardener comprises:
an aliphatic diamine including two primary amines; a phenol; and a cycloaliphatic diamine including two primary amines. By way of example of such a hardener, mention may be made of a hardener sold under the trade name W242 by the company Esprit composite, or
an aliphatic triamine comprising three primary amines. By way of example of such a hardener, mention may be made of a hardener sold under the trade name WWB4 by the company Resoltech.

The hardener can also comprise an aromatic amine, in particular in order to reduce the viscosity of the crosslinkable composition A.

In one embodiment, the [epoxide precursor(s)]/hardener weight ratio in the crosslinkable composition A ranges approximately from 5/6 to 10/3, and preferably approximately from 1.5 to 2.5.

In another embodiment, the crosslinkable composition A also comprises at least one ionic catalyst. Thus, the epoxide polymer material of the first layer can be obtained by polymerization of at least one epoxide precursor as defined in the invention and of at least one ionic catalyst, in particular by homopolymerization.

Said ionic catalyst can be a cationic homopolymerization catalyst, such as a trifluoroboron.

The crosslinkable composition A of the invention can also comprise one or more additives, in particular chosen from plasticizers, pigments and dyes, fillers, and flame retardants. However, these additives must not impair the transparency of the first layer.

The epoxide polymer material of the first layer can also comprise at least one additive chosen from inorganic fillers, stabilizers, gelling agents, and a mixture thereof.

The use of inorganic fillers can make it possible to modulate the mechanical and/or thermal and/or optical properties thereof.

In this embodiment, the crosslinkable composition A can comprise such additives.

By way of example of inorganic fillers, mention may be made of silica (nano)particles or iron (nano)particles.

By way of example of stabilizers, mention may be made of bis(1,2,2,6,6-pentamethyl-4-piperidyl) sebacate.

By way of example of gelling agents, mention may be made of methyl p-toluenesulfonate.

Preferably, the crosslinkable composition A comprises at most 10% by weight of additives, particularly preferably at most 5% by weight of additives, and particularly preferably at most 1% by weight of additives, relative to the total weight of the crosslinkable composition A.

The first layer can have a thickness of at least 2 mm.

The first layer of the upper part represents at least 75% by weight, relative to the total weight of the upper part.

The Second Layer

The second layer of epoxide polymer material of the upper part has a Young's modulus Y₂. This second layer represents a flexible layer, in comparison with the first layer of the upper part. This second layer has good adhesion properties, and is thus capable of adhering to the lower part when the chip is in the closed configuration. Moreover, this second layer is capable of self-regenerating. In other words, after a first use of the chip, the latter can be opened, and again closed for a further use while at the same time preserving good adhesion of the second layer to the lower part. Indeed, the surface of adhesion of the upper part, which corresponds to said at least one part of the second layer directly in physical contact with the lower part of the chip when the chip is in the closed configuration, can undergo a rapid treatment after the opening of the chip, so as to be able to be re-used several times.

The second layer is such that Y₂ is less than or equal to approximately 50 MPa, preferably Y₂ is less than or equal to approximately 25 MPa, particularly preferably Y₂ is less than or equal to approximately 15 MPa, and more particularly preferably Y₂ is less than or equal to approximately 10 MPa.

According to one embodiment of the invention, the second layer has a Young's modulus Y₂ of at least approximately 100 kPa, preferably of at least approximately 500 kPa, and particularly preferably of at least approximately 1 MPa.

The second layer is preferably a transparent layer.

The epoxide polymer material of the second layer can comprise at least approximately 70% by weight of epoxide polymer(s), preferably at least approximately 80% by weight of epoxide polymer(s), particularly preferably at least approximately 90% by weight of epoxide polymer(s), and particularly preferably at least approximately 95% by weight of epoxide polymer(s).

The epoxide polymer material of the second layer can be obtained from a crosslinkable composition B comprising one or more epoxide precursors.

The crosslinkable composition B of the invention can be in the form of a mixture of monomers and/or of oligomers and/or of polymers.

The polymerization of the crosslinkable composition B makes it possible to obtain the epoxide polymer material of the second layer, and thus to form the second layer of the upper part of the chip.

The epoxide precursor can be chosen from cycloaliphatic epoxy resins, polyglycidyl ether epoxy resins, polyglycidyl ester epoxy resins, composite epoxy resins obtained by copolymerization with glycidyl methacrylate, and epoxy resins obtained from unsaturated fatty acid glycerides.

The polyglycidyl ether epoxy resins are particularly preferred.

By way of preferred examples of polyglycidyl ether epoxy resins, mention may be made of the products of the condensation reaction of epichlorohydrin with polyphenols such as bisphenol A or bisphenol F, polyglycidyl ether aliphatic epoxy resins, polyglycidyl ether aromatic epoxy resins, or a mixture thereof.

The polyglycidyl ether epoxy resins are preferably diglycidyl ether epoxides.

According to one preferred embodiment, the crosslinkable composition B comprises at least a first epoxide precursor chosen from the products of the condensation reaction of epichlorohydrin with a polyphenol, preferably the products of the condensation reaction of epichlorohydrin with a polyphenol A or a polyphenol F, and particularly preferably the products of the condensation reaction of epichlorohydrin with a polyphenol A.

The first precursor can represent at least 20% by weight, preferably at least 25% by weight, and particularly preferably at least 30% by weight, relative to the total weight of the crosslinkable composition B.

The first precursor can represent at most 90% by weight, and preferably at most 80% by weight, relative to the total weight of the crosslinkable composition B.

The first precursor may be the only epoxide precursor of the crosslinkable composition B or may be combined with other epoxide precursors.

The crosslinkable composition B can also comprise at least a second epoxide precursor chosen from diglycidyl ether aliphatic epoxy resins, diglycidyl ether aromatic epoxy resins, and the products of the condensation reaction of epichlorohydrin with a polyphenol, and preferably chosen from diglycidyl ether aliphatic epoxy resins, and the products of the condensation reaction of epichlorohydrin with a polyphenol.

The second precursor can represent at least 2% by weight, and preferably at least 4% by weight, relative to the total weight of the crosslinkable composition B.

The second precursor can represent at most 50% by weight, and preferably at most 45% by weight, relative to the total weight of the crosslinkable composition B.

When the crosslinkable composition B comprises a first and a second precursor chosen from the products of the condensation reaction of epichlorohydrin with a polyphenol, said first and second epoxide precursors are different. For example, the crosslinkable composition B can comprise a product of the condensation reaction of epichlorohydrin with bisphenol A, and a product of the condensation reaction of epichlorohydrin with bisphenol F.

The crosslinkable composition B can also comprise at least a third epoxide precursor chosen from monoglycidyl ether aliphatic epoxy resins, and monoglycidyl ether aromatic epoxy resins.

The third precursor can represent at least 2% by weight, and preferably at least 4% by weight, relative to the total weight of the crosslinkable composition B.

The third precursor can represent at most 80% by weight, and preferably at least 70% by weight, relative to the total weight of the crosslinkable composition B.

The polyglycidyl ether aliphatic epoxy resins can be substituted with at least one silane group, such as a trimethoxysilane or triethoxysilane group. The silane group has the function of softening the second layer, and acts as a plasticizer and/or flexibilizing agent.

The crosslinkable composition B can also comprise at least one compound comprising one or more reactive functions, such as acrylate functions.

According to a first particularly preferred embodiment of the invention, the crosslinkable composition B comprises at least one product of the condensation reaction of epichlorohydrin with a polyphenol, at least one monoglycidyl ether aliphatic epoxy resin, at least one monoglycidyl ether aliphatic epoxy resin substituted with a trimethoxysilane group, and at least one diglycidyl ether aliphatic epoxy resin. By way of example of such a mixture of crosslinkable epoxide precursors, mention may be made of the mixture sold under the trade name EC251 by the company Esprit composite, comprising the product of the reaction of bisphenol A with epichlorohydrin as product of the condensation reaction of epichlorohydrin with a polyphenol; C₁₀-C₁₆ alkyl glycidyl ethers as monoglycidyl ether aliphatic epoxy resins; [3-(2,3-epoxypropoxy)propyl]trimethoxysilane as monoglycidyl ether aliphatic epoxy resin substituted with a trimethoxysilane group; and 1,6-bis(2,3-epoxypropoxy)hexane as diglycidyl ether aliphatic epoxy resin.

According to a second particularly preferred embodiment of the invention, the crosslinkable composition B comprises at least two different products of the condensation reaction of epichlorohydrin with a polyphenol, and at least one monoglycidyl ether aliphatic epoxy resin. By way of example of such a mixture of crosslinkable epoxide precursors, mention may be made of the mixture sold under the trade name WWAS or WWA by the company Resoltech, comprising the product of the reaction of bisphenol A with epichlorohydrin as first product of the condensation reaction of epichlorohydrin with a polyphenol; the product of the reaction of bisphenol F with epichlorohydrin as second product of the condensation reaction of epichlorohydrin with a polyphenol, and C₁₀-C₁₆ alkyl glycidyl ethers as monoglycidyl ether aliphatic epoxy resins.

In one particular embodiment, the crosslinkable composition B also comprises at least one hardener. Thus, the epoxide polymer material of the second layer can be obtained by polymerization of a crosslinkable composition B comprising at least one epoxide precursor as defined in the invention and at least one hardener, in particular by polycondensation or by polyaddition, and preferably by polyaddition.

The hardener (or crosslinking agent) can be based on at least one acid anhydride, on at least one polyamine (e.g. (cyclo)aliphatic amines, aromatic amines), on at least one polyamide, on at least one amidoamine, or on a mixture thereof.

By way of examples of acid anhydrides, mention may be made of methyltetrahydrophthalic anhydride (MTHPA), methyl nadic anhydride (MNA) or methylhexahydrophthalic anhydride (MHHPA).

By way of examples of polyamines of aliphatic or cycloaliphatic amine type, mention may be made of those comprising two primary amines such as diethylenetriamine (DETA), tetraethylenetetramine (TETA), polyetheramines (Jeffamine®), or isophorone diamine (IPDA).

By way of examples of polyamides, mention may be made of the products of the condensation of polyamines with acid dimers or fatty acid dimers.

By way of examples of amidoamines, mention may be made of the products of the reaction of carboxylic acids (derived from C₁₆-C₁₉ fatty acids) with aliphatic polyamines (TETA).

By way of examples of polyamines of aromatic amine type, mention may be made of those comprising two primary amines such as 4,4′-diaminodiphenylmethane (DDM), diaminodiphenylsulfone (DDS), methylene-bis(diisopropylaniline) (MPDA) or bis(aminochlorodiethylphenyl)methane (MCDEA).

By way of examples of polyamines of cycloaliphatic or aliphatic amine type, mention may be made of those comprising two or three primary amines such as 3-aminomethyl-3,5,5-trimethylcyclohexylamine, trimethylhexane-1,6-diamine, polyoxypropylene triamine, or poly(propylene glycol)bis(2-aminopropyl ether).

According to one preferred embodiment, the hardener comprises one or more polyamines, in particular one or more diamines and/or triamines, preferably comprising primary amines.

The hardener can also comprise at least one aromatic alcohol, such as benzyl alcohol.

According to one embodiment of the invention, the hardener comprises at least one aliphatic polyamine, preferably including two or three primary amines; optionally at least one cycloaliphatic polyamine, preferably including two or three primary amines; and optionally at least one phenol.

According to one preferred embodiment of the invention, the hardener comprises:
an aliphatic diamine including two primary amines; a phenol; and a cycloaliphatic diamine including two primary amines. By way of example of such a hardener, mention may be made of a hardener sold under the trade name W242 by the company Esprit composite, or
an aliphatic triamine comprising three primary amines. By way of example of such a hardener, mention may be made of a hardener sold under the trade name WWB4 by the company Resoltech.

The hardener can also comprise an aromatic amine, in particular in order to reduce the viscosity of the crosslinkable composition B.

In one embodiment, the [epoxide precursor(s)]/hardener weight ratio in the crosslinkable composition B ranges from 5/6 to 6, preferably approximately from 1 to 10/3, and particularly preferably approximately from 1.5 to 2.5.

In another particular embodiment, the crosslinkable composition B also comprises at least one ionic catalyst. Thus, the epoxide polymer material of the second layer can be obtained by polymerization of at least one epoxide precursor as defined in the invention and of at least one ionic catalyst, in particular by homopolymerization.

Said ionic catalyst can be a cationic homopolymerization catalyst such as trifluoroboron.

The crosslinkable composition B of the invention can also comprise one or more additives, in particular chosen from plasticizers, stabilizers, gelling agents, pigments and dyes, fillers, flame retardants, and a mixture thereof.

The epoxide polymer material of the second layer can also comprise at least one additive chosen from plasticizers, silanes, surfactants, and a mixture thereof. This can make it possible to modulate the mechanical properties thereof and the surface tension thereof. In this embodiment, the crosslinkable composition B can comprise at least one such additive.

By way of example of stabilizers, mention may be made of bis(1,2,2,6,6-pentamethyl-4-piperidyl) sebacate.

By way of example of gelling agents, mention may be made of methyl p-toluenesulfonate.

By way of plasticizers, mention may be made of acrylate compounds, polyglycol derivative reaction products, or propylene carbonate, ethylene carbonate, vinylene carbonate or fluoroethylene carbonate.

Preferably, the crosslinkable composition B comprises at most 10% by weight of additives, particularly preferably at most 5% by weight of additives, and particularly preferably at most 1% by weight of additives, relative to the total weight of the crosslinkable composition B.

In particular, the absence of additives such as plasticizers can make it possible to improve the biocompatibility of the epoxide polymer material of the second layer.

The second layer can have a thickness ranging approximately from 0.2 mm to 2 mm.

According to one embodiment of the invention, the upper part comprises only the first and second layers as defined in the invention.

According to another embodiment, the upper part can comprise n additional layers of an epoxide polymer material inserted between the first and second layers as defined in the invention, with n≥1, each of the n layers having a Young's modulus Yᵢ, with 3≤i≤n; said n layers being such that Y₁>Y₃, Yᵢ>Yᵢ₊₁, and Yₙ>Y₂. Thus, a microfluidic chip upper part with a Young's modulus gradient is obtained.

The second layer represents at most 25% by weight, relative to the total weight of the upper part.

According to one particularly preferred embodiment of the invention:
the epoxide polymer material of the first layer is obtained by polyaddition of a crosslinkable composition A comprising at least a first epoxide precursor chosen from the products of the condensation reaction of epichlorohydrin with a polyphenol, at least a second epoxide precursor chosen from diglycidyl ether aliphatic epoxy resins and the products of the condensation reaction of epichlorohydrin with a polyphenol, and at least one hardener,
the epoxide polymer material of the second layer is obtained by polyaddition of a crosslinkable composition B comprising at least a first epoxide precursor chosen from the products of the condensation reaction of epichlorohydrin with a polyphenol, at least a second epoxide precursor chosen from diglycidyl ether aliphatic epoxy resins and the products of the condensation reaction of epichlorohydrin with a polyphenol, and at least one hardener.

Those skilled in the art know how to vary the respective proportions of said epoxide precursors relative to the hardener, or how to vary the respective proportions of epoxide precursors within a crosslinkable composition, or how to vary the degree of crosslinking of said epoxide precursors, or how to vary the stoichiometry of the functional groups within the epoxide precursors, in order to modulate the Young's modulus of the epoxide material obtained.

By way of example, the [epoxide precursor(s)]/hardener weight ratio in the crosslinkable composition A can be less than or equal to the [epoxide precursor(s)]/hardener weight ratio in the crosslinkable composition B, and preferably strictly less than the [epoxide precursor(s)]/hardener weight ratio in the crosslinkable composition B.

The Upper Part

The upper part is preferably a transparent element.

The upper part can comprise an upper face, which corresponds to the upper face of the chip, and a lower face, which corresponds to the face that comes into contact with the lower part of the chip, and closes said chip. In other words, at least one part of the lower face of the upper part is directly in physical contact with the lower part. The lower face thus comprises the surface of adhesion of the upper part to the lower part of the chip. The surface of adhesion of the upper part is also defined as said at least one part of the second layer which is directly in physical contact with the lower part of the chip when the chip is in the closed configuration.

The upper part preferentially comprises mechanical means configured for manually opening the microfluidic chip, preferably by the lever effect.

According to one preferred embodiment of the invention, the mechanical means are chamfers oriented in such a way that the upper face of the upper part of the chip is of larger dimension than the lower face of said upper part.

In one embodiment of the invention, a part of the edges or all the edges of the upper part are obliquely trimmed, such that the upper face of the upper part is of larger dimension than the lower face of the upper part of the chip.

In one particularly preferred embodiment, the upper part of the chip is in the form of an inverted truncated pyramid.

The angle of the chamfers, relative to the upper face of the upper part of the chip, is preferably greater than approximately 90°, particularly preferably approximately from 100° to 170°, and more particularly preferably approximately from 130 to 160°.

The width D of the chamfers is defined as the distance between the pivot point P and the resultant (or projection) of the opening pressure point A of the chip on the lower part.

The width D of the chamfers can range approximately from 2 mm to 2 cm, and preferably approximately from 5 mm to 1 cm.

The adhesion width Da of the chip is defined as the distance between the pivot point P and the beginning of a microfluidic channel, the pivot point P being at the limit of the adhesion zone or surface.

The width Da can range approximately from 1 mm to 1 cm.

The angle and the width of the chamfers can be modified in order to modulate the adhesion of the upper part of the chip to the lower part thereof, and thus the maximum pressure of use of the chip.

By virtue of the chamfers, it is possible to open the chip easily and rapidly (˜10 seconds) by the lever effect by applying a pressure with the fingers. Moreover, the chip can be rapidly opened (˜10 seconds) in a leaktight manner by simple pressure with the fingers.

The chamfers make it possible to modulate the adhesion of the upper and lower parts to one another, and thus the maximum pressure of use of the chip.

The Lower Part and the Microfluidic Chip

The lower part can have a rectangular shape, in particular with a length of at least 2 cm, and preferably ranging approximately from 2 cm to 20 cm, and with a width of at least 2 cm, and preferably ranging approximately from 2 cm to 20 cm.

The lower part preferably comprises (or consists of) a rigid material, for example a rigid material having a Young's modulus Y′₃ such that Y′₃≥Y₁, Y₁ being as defined in the invention.

In one preferred embodiment of the invention, the Young's modulus Y′₃ is at least approximately 0.1 GPa, preferably at least 0.5 GPa, particularly preferably at least 1 GPa, and more particularly preferably at least approximately 1.5 GPa.

According to a first embodiment of the invention, the lower part comprises a microfluidic structure. In other words, microfluidic channels are in the lower part.

According to this embodiment, the lower part can comprise a support on which a microfluidic structure is deposited.

The support preferably comprises (or consists of) a rigid material, for example a rigid material having a Young's modulus Y′₃ such that Y′₃≥Y₁, Y₁ and Y′₃ being as defined in the invention.

The support can for example be made of a material chosen from glass, a poly(methyl methacrylate) (PMMA), silicon, a cyclic olefin copolymer (COC), polished steel, or any type of rigid material having a Young's modulus greater than or equal to 100 MPa. The rigid material is in particular suitable for withstanding microfabrication steps.

In other words, the support or the lower part is preferably not made of PDMS or silicone which is a flexible material.

The microfluidic structure can be made of a polymer material, in particular chosen from poly(methyl methacrylate) (PMMA), a polyethylene terephthalate (PET), a polytetrafluoroethylene (Teflon), a polyimide (krapton), an epoxy resin, and a cyclic olefin copolymer (COC).

By way of examples of such polymer materials, mention may be made of the epoxy resin SU-8 sold by MicroChem, the polymer materials sold under the Shipley ranges by MicroChem, under the AZ ranges by MicroChemicals, or under the EF ranges by Engineered Materials Systems, Inc.

In a first variant of this first embodiment, the lower face of the upper part can have a planar surface. This first embodiment—first variant—termed “planar version” makes it possible to carry out standard microfluidic studies (i.e. the implementation of 2D flows) more rapidly and more simply than with conventional glass chips, and as simply as with conventional PDMS chips, but offering, by virtue of the variations in aspect ratio of the channels, a greater modularity regarding the flow profiles. The reversible chip obtained also exhibits better robustness.

In a second variant of this first embodiment, the upper part comprises an open cavity on the lower face. In other words, the lower face of the upper part does not have a planar surface. This cavity can in particular be configured for introducing a sample of which it is desired to monitor the reactions, and/or for controlling the contacting and the circulation of fluids on a sample, and/or for observing physicochemical phenomena or measuring parameters with greater precision. This first embodiment—second variant—termed “cavity version” is particularly useful if it is desired to monitor or study physicochemical mechanisms, reaction kinetics, and/or to introduce samples, surfaces or other objects into the chip, on the path of the fluid(s).

The cavity can be of any shape, and more particularly of square or rectangular shape.

Generally, the cavity represents, by volume, approximately from 0.1 to 20% of the total volume of the upper part. This volume can be easily adjusted to the object introduced in order to ensure the preservation of a laminar flow regime.

In the first embodiment—first and second variants—the chips have a high modularity since the lower part comprising the microfluidic structure is interchangeable.

Moreover, the mechanical properties of the first layer of the upper part make it possible to avoid the mechanical deformation of the channels that would induce sagging thereof and lateral stripping during flows under pressure; and consequently make it possible to create channels with high aspect ratios.

In the first embodiment—first and second variants—, the lower part comprises patterns of microfluidic channels preferably having an aspect ratio ranging from 1 to 1600, particularly preferably ranging approximately from 20 to 1600, and more particularly preferably ranging approximately from 30 to 1600.

According to a second embodiment of the invention, the upper part comprises a microfluidic structure. In other words, microfluidic channels are present in the upper part (second embodiment—termed “microfluidic structure version”). In this embodiment, the lower part therefore consists of a support as described in the invention (i.e. without microfluidic structure).

By virtue of the respective Young's moduli Y₁ and Y₂, as defined in the invention, of the first and second layers of the upper part, microchannels with high aspect ratios which are versatile can be easily and rapidly fabricated in the upper part of the chip, without weakening it. This second embodiment is particularly useful for mounting the chip on a production chain in order to functionalize a circulating substrate. It attaches and detaches mechanically, and any type of planar surface can be used as lower part since the channels are in the upper part.

In this second embodiment, the upper part comprises patterns of microfluidic channels preferably having an aspect ratio ranging from 1 to 1600, particularly preferably ranging approximately from 20 to 1600, and particularly preferably ranging approximately from 30 to 1600. It can therefore reach high aspect ratios, only currently obtained with materials of glass or optionally silicon type.

The aspect ratio is defined as the ratio of the width of the channel to its height.

The chip can also comprise fluid inlet and outlet orifices, in particular in the upper part. These inlets and outlets can be connected to a fluid distribution network via suitable tubes.

The total thickness of the chip can be at least approximately 3 mm.

The thickness of the microfluidic structure can range approximately from 50 nm to 500 μm.

The chip is preferably a transparent element.

According to a third embodiment of the invention, the upper part and the lower part of the chip comprise a microfluidic structure.

This embodiment is particularly suitable for fabricating 3D chevron mixers and/or drop generators in terraced form.

Method for Manufacturing the Microfluidic Chip

The second subject of the invention is a method for fabricating a microfluidic chip as defined in the first subject of the invention, characterized in that it comprises at least the following steps:

i) depositing a crosslinkable composition B capable of forming said epoxide polymer material having a Young's modulus Y₂, in a suitable polymer mould of the upper part,

ii) initiating the crosslinking of the crosslinkable composition B,

iii) depositing a crosslinkable composition A capable of forming said epoxide polymer material having a Young's modulus Y₁, on the crosslinkable composition B before complete crosslinking of the crosslinkable composition B,

iv) leaving the crosslinkable compositions A and B to crosslink at ambient temperature for a time sufficient to form respectively the first and second layers of the upper part,

v) demoulding the upper part of the chip comprising the first layer and the second layer, and

vi) optionally, assembling the upper part of the chip with a lower part, such that at least one part of said second layer is directly in physical contact with the lower part of said chip.

Fabrication of the Upper Part

At the end of step i), the lower surface of the mould is preferably totally covered with the crosslinkable composition B.

Depending on the type of upper part fabricated (presence of a microfluidic structure, of a cavity or of neither of the abovementioned two elements), the polymer mould has a suitable shape.

The polymer mould preferably comprises a polysiloxane, and more preferably a polydimethylsiloxane (PDMS).

According to one embodiment, the polymer mould comprises at least one rigid plate, and at least one polymer element deposited on said rigid plate, said polymer element having a shape suitable for being used as a mould of the upper part of the chip.

The rigid plate preferably has a Young's modulus greater than or equal to approximately 100 MPa.

The material of the rigid plate can be chosen from polymers, such as polymethacrylates, or polyacrylates; metals; and ceramics, and preferably polymers.

The polymer of the element can be chosen from polysiloxanes, and preferably polydimethylsiloxanes.

Step i) is preferably carried out at ambient temperature (e.g. approximately 18-25° C.).

The crosslinkable composition B can be as defined in the first subject of the invention.

Step ii) can last from 1 second to 10 hours, and preferably from 30 min to 4 hours.

Step ii) is preferably carried out at ambient temperature.

During step ii), and step iv), the crosslinkable composition B crosslinks and results in the formation of the second layer of the upper part of the chip as defined in the first subject of the invention.

Step iii) is preferably carried out at ambient temperature (e.g. approximately 18-25° C.).

At the end of step iii), the crosslinkable composition B which crosslinks is preferably totally covered with the crosslinkable composition A.

Step iii) is carried out while the crosslinkable composition B has not totally crosslinked or hardened. In other words, the second layer is not formed when the crosslinkable composition A is poured.

Step iii) is preferably carried out when the crosslinkable composition B reaches its gelling point (i.e. when it passes from the fluid state to the viscoelastic solid state). In other words, step iii) is preferably carried out when the crosslinkable composition B no longer gives any relaxation induced by surface tension.

The crosslinkable composition A can be as defined in the first subject of the invention.

Step iv) can last from 1 second to 72 hours, and preferably from 12 to 48 hours.

During step iv), the crosslinkable compositions A and B crosslink and result respectively in the formation of the first and second layers of the upper part of the chip as defined in the first subject of the invention.

The method can also comprise, before step i), a step i₀) of preparing the crosslinkable composition B.

The method can also comprise, before step iii), a step iii₀) of preparing the crosslinkable composition A.

Steps i₀) and iii₀) can be concomitant.

The method can also comprise, before step i), a step a) of fabricating the polymer mould of the upper part.

Step a) can comprise at least one substep a₁) of preparing a polymer model of the upper part, and a substep a₂) of moulding with said polymer model.

According to the desired polymer model (upper part of the chip with a planar surface, a microfluidic structure, or a cavity), the substep a₁) can comprise the implementation of moulding, photolithography, machining, etc., substep(s) well known to those skilled in the art.

The polymer material of the model can be chosen from polyacrylates, polymethacrylates, epoxy resins, and any type of polymer material having a Young's modulus greater than or equal to approximately 100 MPa.

Preferably, the models of the “cavity version” and “microfluidic structure version” upper part are made of epoxy resin, and the model of the “planar version” upper made is made of PMMA.

Fabrication of the Lower Part

When the lower part comprises a microfluidic structure, it can be fabricated by photolithography. This method is well known to those skilled in the art.

It generally implements lamination or spin coating of a film of photosensitive resin, the application of a mask on the photosensitive resin or another technique (digital-masking photolithography, etc.), the targeted insolation of the photosensitive resin, and a developing step, the operational conditions of which are adjusted according to the photosensitive resin used (immersion in a solvent which dissolves only the insolated or non-insolated resin, often followed by annealing of the remaining resin at a precise temperature). The resin of the channels is then dissolved.

The assembly step vi) can comprise positioning the upper part of the chip on the lower part, and applying a homogeneous pressure on the upper part of the chip. The “bilayer” composition of the upper part both allows sealed closing and at the same time prevents swelling of the channels and stripping thereof.

Step vi) can also comprise, prior to the positioning of the upper part of the chip on the lower part, sprinkling of the surface of adhesion of the upper part with an organic solvent such as acetone or ethanol; followed by drying of said surface of adhesion; and optionally the introduction of a sample into the cavity of the upper part if said cavity exists.

The sprinkling and the drying are particularly useful when the chip has already been used. These steps make it possible to increase the adhesive capacity of the surface of adhesion of the upper part so that the chip can be effectively sealed once again.

The sprinkling and the drying are preferably carried out at ambient temperature.

The drying can be carried out with compressed air.

The microfluidic chip of the invention can be opened, in particular by application of a localized pressure at the mechanical means of the invention, and preferably above the chamfers, of the upper part.

The microfluidic chip of the invention can be re-used by virtue of the sprinkling and drying of the upper part of the chip. These steps make it possible to increase the adhesion. Self-regeneration occurs on a timescale ranging from 1 to 15 days and makes it possible to completely relax the surface of adhesion which returns to its initial topography.

The method can also comprise, between steps v) and vi), a step of piercing holes through the upper part in order to create fluid inlet and outlet orifices.

Use of the Upper Part

The third subject of the invention is the use of an upper part comprising at least a first layer of an epoxide polymer material having a Young's modulus and at least a second layer of an epoxide polymer material having a Young's modulus Y₂, said first and second layers being such that:
the Y₁/Y₂ ratio is greater than or equal to 50, and
Y₂ is less than or equal to 50 MPa,

in a reversible microfluidic chip.

The microfluidic chip, the upper part, the first and second layers of the upper part, Y₁ and Y₂ can be as defined in the first subject of the invention.

In particular, the upper part as defined in the third subject of the invention can make it possible to produce a microfluidic chip in accordance with the first subject of the invention.

The fourth subject of the invention is an upper part for producing a microfluidic chip in accordance with the first subject of the invention, characterized in that it comprises at least a first layer of an epoxide polymer material having a Young's modulus Y₁, and at least a second layer of an epoxide polymer material having a Young's modulus Y₂, said first and second layers being such that:
the ratio Y₁/Y₂ is greater than or equal to 50, and
Y₂ is less than or equal to 50 MPa, and

in that said upper part also comprises mechanical means configured for manually opening said microfluidic chip.

The microfluidic chip, the upper part, the first and second layers of the upper part, Y₁ and Y₂ and the mechanical means can be as defined in the first subject of the invention.

Uses

The fifth subject of the invention is the use of a microfluidic chip as defined in the first subject of the invention, in medical, biotechnological, biological, analysis, chemical synthesis, or clinical diagnosis applications.

More particularly, the microfluidic chip can be used for automating biological tests, which are preferably relatively simple (immunoassay, blood chemistry, blood gases), new generation sequencing (NGS), point-of-care diagnostic tests, genetic analysis, capillary electrophoresis, DNA amplification, cell biology, proteomics, diagnostics, drug research, the synthesis of molecules or nanomaterials, or kinetic studies.

The chip of the invention can also be used with all the conventional functionalities of conventional microfluidic chips (laminar flow, mixer, drop generator, etc.), in low Reynolds number hydrodynamic study for high and versatile aspect ratio ranges, or in the study of 2D assemblies of drops and bubbles and parallel flow of several phases (liquid and/or gas).

The “cavity version” chip can be used for in situ visualization of the interaction of fluids with an object, a sample, or an exterior surface introduced into the cavity (adsorption, solubilization, crystal growth from a seed, cell culture, organ-on-chip, chemical reaction in batch-mode medium, etc.). More particularly, it can be used for kinetic studies of assembly by nano-xerography of nanoparticles on solid substrates. The in situ observation, through said cavity, of the adsorption of particles can offer an experimental support for backing up theory, and/or can make it possible to rapidly choose the parameters most suitable for each nano-xerography protocol (concentration, adsorption time, etc.). Nano-xerography consists in electrostatically assembling charged and/or polarizable colloidal nanoparticles on charged patterns at the surface of a thin layer of electret.

Other characteristics and advantages of the present invention will emerge in the light of the description of non-limiting examples of chips according to the invention, given with reference to the figures.

### EXAMPLES

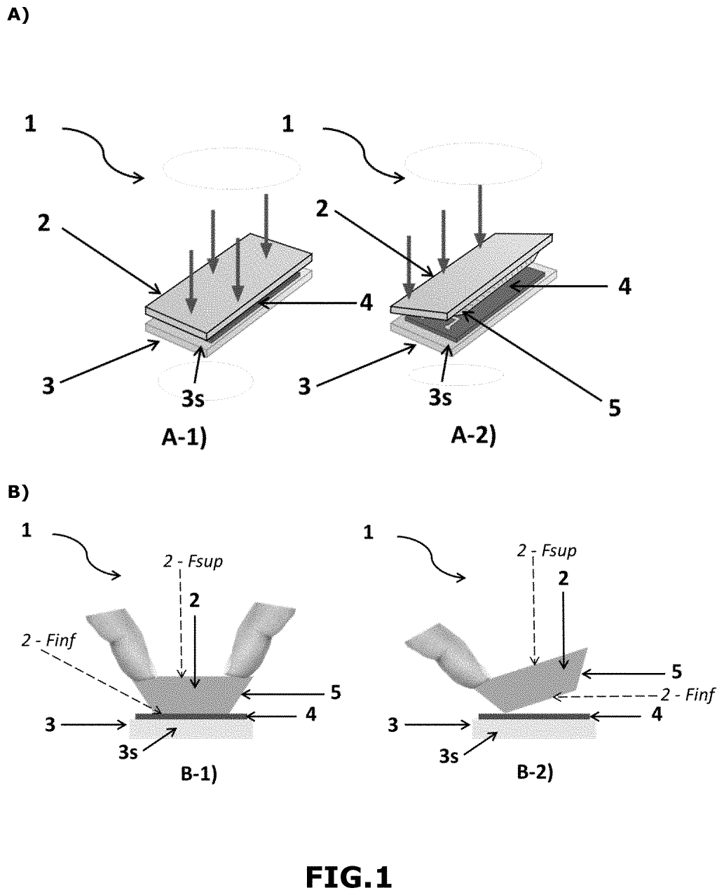

FIG. 1 shows a diagrammatic representation of the opening and closing of a chip 1 in accordance with the first subject of the invention. In particular, FIG. 1A is a view from above of the closing [FIG. A-1)] and opening [FIG. A-2)] of a chip 1 in accordance with the first subject of the invention, and FIG. 1B is a sectional view of the closing [FIG. B-1)] and opening [FIG. B-2)] of a chip 1 in accordance with the first subject of the invention.

The chip 1 comprises an upper part 2, and a lower part 3 comprising a microfluidic structure 4. The lower part 3 comprises a support 3s on which a microfluidic structure 4 is deposited. The upper part 2 is configured for coming into contact with said lower part 3 and closing said chip 1. The upper part 2 comprises chamfers 5 which allow manual opening of the microfluidic chip, in particular by the lever effect. The chamfers 5 are oriented in such a way that the upper face 2-Fsup of the upper part 2 of the chip is of larger dimension than the lower face 2-Finf of said upper part 2 [cf. Figures B-1) and B-2)].

The opening and closing of the chip 1 can be carried out by simple manual pressure (vertical arrows in Figure A-1)) by virtue of the adhesion capacity of the flexible second layer of the upper part 2 of the chip 1, and optionally the presence of chamfers 5. Sealed and uniform closing is thus ensured by the adhesion of at least one part of the second layer with the lower part 3, after application of a uniform pressure over the entire surface of the closed chip [Figures A-1) and B-1)]. Opening is permitted by application of a local manual pressure (vertical arrows in Figure A-2)) at the edge of the chip by the lever effect with the chamfers 5 [Figures A-2) and B-2)]. This reversibility makes it possible to deposit for example a sample in the chip for the monitoring of a reaction by the microfluidic route, and then to recover it at the end of reaction monitoring and subsequently re-use the upper part 2 and lower part 3 of the chip. Since the geometry of the chamfers 5 is adjustable for creating the upper part 2, it is possible to modulate the adhesion between the two parts of the chip 1 and therefore the working pressure during monitoring of a reaction (e.g. pressure ranging approximately from 0 to 1.5 bar). The chamfers 5 are mechanical means that are much simpler and much less bulky than a conventional tightening system. In particular, they do not prevent observation of the interior of the chip. They also make it possible to limit the number of constituents of the chip 1 and to work more rapidly. The chip can be completely transparent, thereby enabling in-situ observations with wavelengths throughout the visible range with a minimum value of 400 nm. It is thus possible to envisage monitoring a reaction by photoluminescence under excitation at 450 nm.

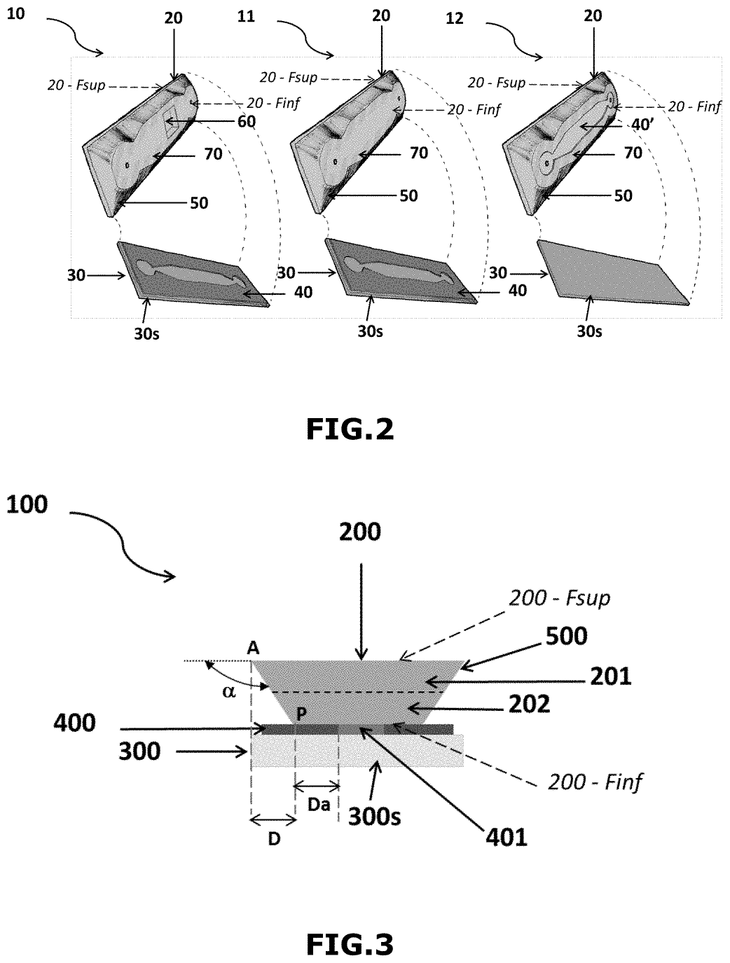

FIG. 2 shows three chips 10, 11, and 12 in accordance with the invention respectively according to the “cavity version”, “planar version” and “microfluidic structure version” embodiments. The chips 10, 11 and 12 comprise an upper part 20 optionally comprising a microfluidic structure 40′, and a lower part 30 comprising a support 30s on which a microfluidic structure 40 is optionally deposited. The upper part 20 is configured for coming into contact with said lower part 30 and closing said chip 10, 11 or 12. The upper part 20 comprises chamfers 50 which allow manual opening of the microfluidic chip, in particular by the lever effect. The chamfers 50 are oriented in such a way that the upper face 20-Fsup of the upper part 20 of the chip is of larger dimension than the lower face 20-Finf of said upper part 20. The surface 70, termed “surface of adhesion”, denotes the surface of the lower face 20-Finf of the upper part 20 which is directly in physical contact with the lower part 30 of the chip when said chip is in the closed configuration. The surface of adhesion 70 corresponds to the part of the second layer of the upper part directly in physical contact with the lower part of the chip.

In the chip 10, the upper part 20 comprises a cavity 60 open on the lower face 20-Finf, and the lower part 30 comprises a support 30s on which a microfluidic structure 40 is deposited (“cavity version” chip). In the chip 11, the lower face 20-Finf of the upper part 20 has a planar surface, and the lower part 30 comprises a support 30s on which a microfluidic structure 40 is deposited (“planar version” chip). In the chip 12, the upper part 20 comprises a microfluidic structure 40′ and the lower part 30 has a planar surface and consists of a support 30s.

FIG. 3 is a sectional diagrammatic representation of a chip 100 in accordance with the invention.

The chip 100 comprises an upper part 200, and a lower part 300 comprising a support 300s on which a microfluidic structure 400 comprising at least one microfluidic channel 401 is deposited. The upper part 200 is configured for coming into contact with said lower part 300 and closing said chip 100. The upper part 200 comprises chamfers 500 which allow manual opening of the microfluidic chip, in particular by the lever effect. The chamfers 500 are oriented in such a way that the upper face 200-Fsup of the upper part 200 of the chip is of larger dimension than the lower face 200-Finf of said upper part 200. The upper part 200 comprises at least a first layer 201 of an epoxide polymer material having a Young's modulus Y₁, and at least a second layer 202 of an epoxide polymer material having a Young's modulus Y₂, said Young's moduli Y₁ and Y₂ being as defined in the invention. At least one part of said second layer 202 (surface of adhesion) is directly in physical contact with the lower part 300 of said chip 100 when the chip is in the closed configuration.

The angle α of the chamfers, relative to the upper face 200-Fsup of the upper part 200 of the chip 100, is preferentially between 130 and 160°.

P is defined as being the “pivot point”, and A is defined as being the chip opening pressure point. The width D of the chamfers is defined as the distance between the pivot point P and the resultant (or projection) of the opening pressure point A on the lower part 300. The width D is approximately 5 mm, when the angle α is 130°, and approximately 1 cm when the angle α is 160°.

The adhesion width Da is defined as the distance between the pivot point P and the beginning of a microfluidic channel 401.

Other chips can be envisaged according to the invention, in particular a chip in which the lower and upper parts each comprise a microfluidic structure and/or microfluidic structures on several stages.

### Example 1: Fabrication of a “Planar Version” Chip

### 1.1 Fabrication of a “Planar Version” Upper Part Model

A first rectangular piece PMMA with dimensions of 76×26×5 mm is prepared and trimmed using a drill with router heads (of Dremel type), so as to create chamfers. This first piece of PMMA represents the “planar version” upper part model.

### 1.2 Fabrication of a “Planar Version” Upper Part Mould

A second rectangular piece of PMMA with dimensions of 96×46×5 mm is prepared. A piece of adhesive tape approximately 5 cm wide is stuck to a part of the piece of PMMA, so as to act as formwork for the mould. A crosslinkable composition of PDMS sold under the reference Sylgard 184 is then poured over the piece of PMMA, so as to form a first layer of PDMS with a thickness of approximately 5 to 10 mm deposited on the piece of PMMA. The assembly is left at 60° C. for 40 to 60 minutes, then a crosslinkable composition of PDMS sold under the reference Sylgard 184 is poured onto the previously formed layer of PDMS, so as to form a second layer of PDMS. While this second layer is still liquid, the “planar version” upper part model previously obtained is incorporated into the second layer of PDMS until it is totally immersed, the chamfered face of the model facing downwards. The assembly is then left at 60° C. for 24 h. The surplus PDMS above the model is then cut away and the model is demoulded using compressed air.

### 1.3 Fabrication of a “Planar Version” Upper Part

2 g of an epoxy resin sold under the tradename EC251 is mixed with 1 g of a hardener sold under the tradename W242.

The crosslinkable composition B obtained is degassed, then 2 g are poured into the mould obtained in example 1.2 above, so as to totally cover the bottom of the mould. The crosslinkable composition B is left to crosslink at ambient temperature for 4 hours.

In parallel, 6 g of an epoxy resin sold under the tradename EC161 is mixed with 3 g of a hardener sold under the tradename W242. The crosslinkable composition A obtained is degassed, then 6 g of this crosslinkable composition A are poured onto the crosslinkable composition B in the mould before the composition B has finished crosslinking. The crosslinkable compositions A and B are then left to crosslink for 24 h.

The upper part thus obtained is demoulded using compressed air, then pierced to form flow inlet and outlet orifices, using a tool of Dremel type.

### 1.4 Fabrication of a “Planar Version” Chip

The lower part is fabricated by lamination of a photosensitive resin on a glass slide and photolithography, under non-actinic conditions. To do this, a microscope slide with dimensions of 76×26×1.2 mm is cleaned, then heated for 1 to 2 minutes at 100° C. It is then cleaned with a plasma. A photosensitive resin sold under the reference DF-3050 by Engineered Materials Systems Inc. is deposited on the glass slide by laminating at a speed of approximately 1 cm/s and at a temperature of 98° C. A glass slide covered with a mask containing the patterns of the microchannels is then deposited on the laminated glass slide, and the assembly is insolated using a device sold under the tradename UV-KUB 3, for 9 seconds at 100% power. The mask is then removed, and the laminated slide is annealed at 100° C. for 10 minutes, and developed in cyclohexanone between 9 and 11 minutes. The assembly obtained is annealed at 175° C. for 1 h.

The surface of adhesion of the upper part intended to be in contact with the lower part of the chip is sprinkled with acetone and then dried with compressed air. The upper part is then positioned on the lower part comprising the microfluidic structure. The chip is then closed by simple pressure of the fingers on the upper part.

### Example 2: Fabrication of a “Microfluidic Structure Version” Chip

### 2.1 Fabrication of a “Microfluidic Structure Version” Upper Part Model

A microscope slide with dimensions of 76×26×1.2 mm is cleaned, then heated for 1 to 2 minutes at 100° C. It is then cleaned with a plasma. A photosensitive resin sold under the reference DF-3050 by Engineered Materials Systems Inc. is deposited on the glass slide by lamination at a speed of a few cm/s and at a temperature of 98° C. A glass slide covered with a mask containing the patterns of the microchannels is then deposited on the laminated glass slide, and the assembly is insolated using a device sold under the tradename UV-KUB 3, for 9 seconds at 100% power. The mask is then removed, and the laminated slide is annealed at 100° C. for 10 minutes, and developed in cyclohexanone for between 9 and 11 minutes. The assembly obtained is annealed at 175° C. for 1 h. A glass slide comprising reliefs of the photosensitive resin representing the negative of the fluid microfluidic structure is obtained.

In parallel, a rectangular piece of PMMA with dimensions of 96×46×5 mm is prepared. A piece of adhesive tape approximately 5 cm wide is stuck on a part of the piece of PMMA, so as to act as formwork for the mould. A crosslinkable composition of PDMS sold under the reference Sylgard 184 is then poured onto the piece of PMMA, so as to form a first layer of PDMS with a thickness of approximately 5 to 10 mm deposited on the piece of PMMA. The assembly is left at 60° C. for 40 to 60 minutes and then it is left to cool at ambient temperature. A crosslinkable composition of PDMS sold under the reference Sylgard 184 is poured onto the layer of PDMS previously formed, so as to form a second layer of PDMS. While this second layer is still liquid, the glass slide comprising reliefs of the photosensitive resin previously obtained is deposited on the first layer of PDMS, until it is totally immersed, the reliefs being positioned facing downwards (i.e. photolithography face downwards). The assembly is then left at ambient temperature for 48 h. The surplus PDMS above the glass slide and the reliefs is then cut away, and removed with the glass slide, and a premould is obtained.

A crosslinkable composition comprising an epoxy resin sold under the reference EC 161 and a hardener sold under the tradename W242, the hardness/epoxy resin weight ratio being 1/2, is then poured into the premould. The assembly is left at ambient temperature for 48 h, then the part made of epoxy resin is demoulded using compressed air. This part made of epoxy resin is trimmed using a drill with router heads (Dremel type), so as to create chamfers, in order to form a “microfluidic structure version” upper part model.

### 2.2 Fabrication of a “Microfluidic Structure Version” Upper Part Mould

A rectangular piece of PMMA with dimensions of 96×46×5 mm is prepared. A piece of adhesive tape approximately 5 cm wide is stuck on a part of the piece of PMMA, so as to act as formwork for the mould. A crosslinkable composition of PDMS sold under the reference Sylgard 184 is then poured onto the piece of PMMA, so as to form a first layer of PDMS deposited on the piece of PMMA. The assembly is left at 60° C. for 40 to 60 minutes before being left to cool to ambient temperature, then a crosslinkable composition of PDMS sold under the reference Sylgard 184 is poured onto the layer of PDMS previously formed, so as to form a second layer of PDMS. While this second layer is still liquid, the “microfluidic structure version” upper part model previously obtained is incorporated into the second layer of PDMS until it is totally immersed, the lower face of the upper part model facing downwards. The assembly is then left at ambient temperature for 48 h. The surplus PDMS above the model is then cut away and the model is demoulded using compressed air.

### 2.3 Fabrication of a “Microfluidic Structure Version” Upper Part

2 g of an epoxy resin sold under the tradename EC251 are mixed with 1 g of a hardener sold under the tradename W242. The crosslinkable composition B obtained is degassed, then 2 g are poured into the mould obtained in example 2.2 above, so as to totally cover the bottom of the mould. The crosslinkable composition B is left to crosslink at ambient temperature for 4 hours.

In parallel, 6 g of an epoxy resin sold under the tradename EC161 is mixed with 3 g of a hardener sold under the tradename W242. The crosslinkable composition A obtained is degassed, then 6 g of this crosslinkable composition A are poured onto the crosslinkable composition B in the mould. The crosslinkable compositions A and B are left to crosslink for 24 h at ambient temperature.

The upper part thus obtained is demoulded using compressed air, then pierced to form flow inlet and outlet orifices.

### 2.4 Fabrication of a “Microfluidic Structure Version” Chip

A simple glass slide with dimensions of 26×76×1.2 mm is used as lower part.

The surface of adhesion of the upper part intended to be in contact with the lower part of the chip is sprinkled with acetone for a few seconds, then dried with compressed air. The upper part comprising the microfluidic structure is then positioned on the lower part. The chip is then closed by simple pressure of the fingers on the upper part.

### Example 3: Fabrication of a “Cavity Version” Chip

### 3.1 Fabrication of a “Cavity Version” Upper Part Model

The “planar version” upper part mould as fabricated in example 1.2 above is used as premould for preparing the “cavity version” upper part model. To do this, an object with dimensions of 10×10×3 mm comprising a magnetized part (the dimensions of the object are those that it is then desired to obtain for the cavity) is positioned in the premould at the desired position. A magnet is positioned under the premould in order to ensure contact of the object with the premould. Since the two magnets attract one another, the passage under the object of the crosslinkable composition as described hereinafter is limited.

Next, a crosslinkable composition comprising an epoxy resin sold under the reference EC 161 and a hardener sold under the tradename W242, the hardness/epoxy resin weight ratio being 1/2, is poured into the premould, so as to immerse the object. The assembly is left for 48 h at ambient temperature, the magnet under the premould is removed, the part made of epoxy resin surrounding the object and the object are demoulded together using compressed air, and the object is removed using a magnet so as to form a “cavity version” upper part model.

### 3.2 Fabrication of a “Cavity Version” Upper Part Mould

A rectangular piece of PMMA with dimensions of 96×46×5 mm is prepared. A piece of adhesive tape approximately 5 cm wide is stuck on a part of the piece of PMMA, so as to serve as formwork for the mould. A crosslinkable composition of PDMS sold under the reference Sylgard 184 is then poured onto the piece of PMMA, so as to form a first layer of PDMS deposited on the piece of PMMA. The assembly is left at 60° C. for 40 to 60 minutes, then a crosslinkable composition of PDMS sold under the reference Sylgard 184 is poured onto the layer of PDMS previously formed, so as to form a second layer of PDMS. While this second layer is still liquid, the “cavity version” upper part model previously obtained is incorporated into the second layer of PDMS until it is totally immersed, the lower face of the upper part model facing downwards. The assembly is then left at 60° C. for 24 h. The surplus PDMS above the model is then cut away and the model is demoulded using compressed air.

### 3.3 Fabrication of a “Cavity Version” Upper Part

2 g of an epoxy resin sold under the tradename EC251 are mixed with 1 g of a hardener sold under the tradename W242. The crosslinkable composition B obtained is degassed, then 2 g are poured into the mould obtained in example 3.2 above, so as to totally cover the bottom of the mould. The crosslinkable composition B is left to crosslink at ambient temperature for 4 hours.

In parallel, 6 g of an epoxy resin sold under the tradename EC161 are mixed with 3 g of a hardener sold under the tradename W242. The crosslinkable composition A obtained is degassed, then 6 g of this crosslinkable composition A are poured onto the crosslinkable composition B in the mould. The crosslinkable compositions A and B are left to crosslink for 24 h.

The upper part of the chip thus obtained is demoulded using compressed air, then pierced to form flow inlet and outlet orifices, using a tool of Dremel type.

### 3.4 Fabrication of a “Cavity Version” Chip

The lower part is fabricated by spin coating of a photosensitive resin on a glass slide and photolithography, under non-actinic conditions. The method used in example 1 can also be carried out.

To do this, a microscope slide with dimensions of 76×26×1.2 mm is used. A compound sold under the reference AZ1512HS by MicroChemicals is deposited by spincoating at a speed of 5000 revolutions per minute and at ambient temperature. The spin-coated slide is annealed at 100° C. for 2 minutes and insolated using a device sold under the tradename digital SmartPrint, equipped with a 1× objective: 10.2 mW/cm² for 15 seconds at 150 mJ/cm² of power. The spin-coated slide is then developed in an aqueous solution containing 50% by volume of AZ1500 for 45 seconds, and washed in a bath of demineralized water. The assembly obtained is dried and then annealed at 110° C. for 1 min.

The surface of adhesion of the upper part intended to be in contact with the lower part of the chip is sprinkled with acetone for a few seconds and then dried with compressed air. The object or sample to be analysed is placed in the cavity with a magnet of the same format as that used to make the model. The upper part comprising the cavity is then positioned on the lower part. The chip is then closed by simple pressure of the fingers on the upper part.

### Example 4: Fabrication of a “Planar Version” Chip

### 4.1 Fabrication of a “Planar Version” Upper Part Model

A first rectangular piece of PMMA of dimensions of 76×26×5 mm is prepared and trimmed using a drill with router heads (of Dremel type), so as to create chamfers. This first piece of PMMA represents the “planar version” upper part model.

### 4.2 Fabrication of a “Planar Version” Upper Part Mould

A second rectangular piece of PMMA with dimensions of 96×46×5 mm is prepared. A piece of adhesive tape approximately 5 cm wide is stuck on a part of the piece of PMMA, so as to serve as formwork for the mould. A crosslinkable composition of PDMS sold under the reference Sylgard 184 is then poured onto the piece of PMMA, so as to form a first layer of PDMS with a thickness of approximately 5 to 10 mm deposited on the piece of PMMA. The assembly is left at 60° C. for 40 to 60 minutes, then a crosslinkable composition of PDMS sold under the reference Sylgard 184 is poured onto the layer of PDMS previously formed, so as to form a second layer of PDMS. While this second layer is still liquid, the “planar version” upper part mould previously obtained is incorporated into the second layer of PDMS until it is totally immersed, the chamfered face of the model facing downwards. The assembly is then left at 60° C. for 24 h. The surplus PDMS above the model is then cut away and the model is demoulded using compressed air.

### 4.3 Fabrication of a “Planar Version” Upper Part

2 g of an epoxy resin sold under the tradename WWAS are mixed with 0.54 g of a hardener sold under the tradename WWB4.

The crosslinkable composition B obtained is degassed, then 2 g are poured into the mould obtained in example 4.2 above, so as to totally cover the bottom of the mould. The crosslinkable composition B is left to crosslink at ambient temperature for 1 hour.

In parallel, 6 g of an epoxy resin sold under the tradename WWAS is mixed with 2.4 g of a hardener sold under the tradename WWB4. The crosslinkable composition A obtained is degassed, then 6 g of this crosslinkable composition A are poured onto the crosslinkable composition B in the mould before the composition B has finished crosslinking. The crosslinkable compositions A and B are then left to crosslink for 24 h.

The upper part thus obtained is demoulded using compressed air, then pierced to form flow inlet and outlet orifices, using a tool of Dremel type.

### 4.4 Fabrication of a “Planar Version” Chip

The lower part is fabricated by lamination of a photosensitive resin on a glass slide and photolithography, under non-actinic conditions. To do this, a microscope slide with dimensions of 76×26×1.2 mm is cleaned, then heated for 1 to 2 minutes at 100° C. It is then cleaned with a plasma. A photosensitive resin sold under the reference DF-3050 by Engineered Materials Systems Inc. is deposited on the glass slide by lamination at a speed of approximately 1 cm/s and at a temperature of 98° C. A glass slide covered with a mask containing the patterns of the microchannels is then deposited on the laminated glass slide, and the assembly is insolated using a device sold under the tradename UV-KUB 3, for 9 seconds at 100% power. The mask is then removed, and the laminated slide is annealed at 100° C. for 10 minutes, and developed in cyclohexanone for between 9 and 11 minutes. The assembly obtained is annealed at 175° C. for 1 h.

The surface of adhesion of the upper part intended to be in contact with the lower part of the chip is sprinkled with acetone and then dried with compressed air. The upper part is then positioned on the lower part comprising the microfluidic structure. The chip is then closed by simple pressure of the fingers on the upper part.

### Example 5: Fabrication of a “Microfluidic Structure Version” Chip

### 5.1 Fabrication of a “Microfluidic Structure Version” Upper Part Model

A microscope slide with dimensions of 76×26×1.2 mm is cleaned, then heated for 1 to 2 minutes at 100° C. It is then cleaned with a plasma. A photosensitive resin sold under the reference DF-3050 by Engineered Materials Systems Inc. is deposited on the glass slide by lamination at a speed of a few cm/s and at a temperature of 98° C. A glass slide covered with a mask containing the patterns of the microchannels is then deposited on the laminated glass slide, and the assembly is insolated using a device sold under the tradename UV-KUB 3, for 9 seconds at 100% power. The mask is then removed, and the laminated slide is annealed at 100° C. for 10 minutes, and developed in cyclohexanone for between 9 and 11 minutes. The assembly obtained is annealed at 175° C. for 1 h. A glass slide comprising reliefs of the photosensitive resin representing the negative of the final microfluidic structure is obtained.

In parallel, a rectangular piece of PMMA with dimensions of 96×46×5 mm is prepared. A piece of adhesive tape approximately 5 cm wide is stuck on a part of the piece of PMMA, so as to serve as formwork for the mould. A crosslinkable composition of PDMS sold under the reference Sylgard 184 is then poured onto the piece of PMMA, so as to form a first layer of PDMS with a thickness of approximately 5 to 10 mm deposited on the piece of PMMA. The assembly is left at 60° C. for 40 to 60 minutes, and is then left to cool at ambient temperature. A crosslinkable composition of PDMS sold under the reference Sylgard 184 is poured onto the layer of PDMS previously formed, so as to form a second layer of PDMS. While this second layer is still liquid, the glass slide comprising reliefs of the photosensitive resin previously obtained is deposited on the first layer of PDMS, until it is totally immersed, the reliefs being positioned facing downwards (i.e. photolithography face downwards). The assembly is then left at ambient temperature for 48 h. Next, the surplus PDMS above the glass slide and the reliefs is cut away, and removed with the glass slide, and a premould is obtained.

Next, a crosslinkable composition comprising an epoxy resin sold under the reference WWAS and a hardener sold under the tradename WWB4, the hardness/epoxy resin weight ratio being 100/40, is poured into the premould. The assembly is left for 48 h at ambient temperature, then the part made of epoxy resin is demoulded using compressed air. This part made of epoxy resin is trimmed using a drill with router heads (of Dremel type), so as to create chamfers, in order to form a “microfluidic structure version” upper part model.

### 5.2 Fabrication of a “Microfluidic Structure Version” Upper Part Mould

A rectangular piece of PMMA with dimensions of 96×46×5 mm is prepared. A piece of adhesive tape approximately 5 cm wide is stuck on a part of the piece of PMMA, so as to serve as formwork for the mould. A crosslinkable composition of PDMS sold under the reference Sylgard 184 is then poured onto the piece of PMMA, so as to form a first layer of PDMS deposited on the piece of PMMA. The assembly is left at 60° C. for 40 to 60 minutes before being left to cool to ambient temperature, then a crosslinkable composition of PDMS sold under the reference Sylgard 184 is poured onto the layer of PDMS previously formed, so as to form a second layer of PDMS. While this second layer is still liquid, the “microfluidic structure version” upper part model previously obtained is incorporated into the second layer of PDMS until it is totally immersed, the lower face of the upper part model facing downwards. The assembly is then left at ambient temperature for 48 h. The surplus PDMS above the model is then cut away and the model is demoulded using compressed air.

### 5.3 Fabrication of a “Microfluidic Structure Version” Upper Part

2 g of an epoxy resin sold under the tradename WWAS is mixed with 0.54 g of a hardener sold under the tradename WWB4. The crosslinkable composition B obtained is degassed, then 2 g are poured into the mould obtained in example 5.2 above, so as to totally cover the bottom of the mould. The crosslinkable composition B is left to crosslink at ambient temperature for 1 hour.

In parallel, 6 g of an epoxy resin sold under the tradename WWAS are mixed with 2.4 g of a hardener sold under the tradename WWB4. The crosslinkable composition A obtained is degassed, then 6 g of this crosslinkable composition A are poured onto the crosslinkable composition B in the mould. The crosslinkable compositions A and B are left to crosslink for 24 h at ambient temperature.

The upper part thus obtained is demoulded using compressed air, then pierced to form flow inlet and outlet orifices.

### 5.4 Fabrication of a “Microfluidic Structure Version” Chip

A simple glass slide with dimensions of 26×76×1.2 mm is used as lower part.

The surface of adhesion of the upper part intended to be in contact with the lower part of the chip is sprinkled with acetone for a few seconds, then dried with compressed air. The upper part comprising the microfluidic structure is then positioned on the lower part. The chip is then closed by simple pressure of the fingers on the upper part.

### Example 6: Fabrication of a “Cavity Version” Chip

### 6.1 Fabrication of a “Cavity Version” Upper Part Model

The mould of the “planar version” upper part as fabricated in example 4.2 above is used as premould for preparing the model of the “cavity version” upper part model. To do this, an object with dimensions of 10×10×3 mm comprising a magnetized part (the dimensions of the object are those that it is subsequently desired to obtain for the cavity) is positioned in the premould in the desired place. A magnet is positioned under the premould in order to ensure contact of the object with the premould. Since the two magnets attract one another, the passage under the object of the crosslinkable composition as described hereinafter is limited.

Next, a crosslinkable composition comprising an epoxy resin sold under the reference WWAS and a hardener sold under the tradename WWB4, the hardness/epoxy resin weight ratio being 100/40, is poured into the premould, so as to immerse the object. The assembly is left for 48 h at ambient temperature, the magnet under the premould is removed, the part made of epoxy resin surrounding the subject and the subject are demoulded together using compressed air, and the object is removed using a magnet so as to form a “cavity version” upper part model.

### 6.2 Fabrication of a “Cavity Version” Upper Part Mould

A rectangular piece of PMMA with dimensions of 96×46×5 mm is prepared. A piece of adhesive tape approximately 5 cm wide is stuck on a part of the piece of PMMA, so as to serve as formwork for the mould. A crosslinkable composition of PDMS sold under the reference Sylgard 184 is then poured onto the piece of PMMA, so as to form a first layer of PDMS deposited on the piece of PMMA. The assembly is left at 60° C. for 40 to 60 minutes, then a crosslinkable composition of PDMS sold under the reference Sylgard 184 is poured onto the layer of PDMS previously formed, so as to form a second layer of PDMS. While this second layer is still liquid, the “cavity version” upper part model previously obtained is incorporated into the second layer of PDMS until it is totally immersed, the lower face of the upper part model facing downwards. The assembly is then left at 60° C. for 24 h. The surplus PDMS above the model is then cut away and the model is demoulded using compressed air.

### 6.3 Fabrication of a “Cavity Version” Upper Part

2 g of an epoxy resin sold under the tradename WWAS are mixed with 0.54 g of a hardener sold under the tradename WWB4. The crosslinkable composition B obtained is degassed, then 2 g are poured into the mould obtained in example 6.2 above, so as to totally cover the bottom of the mould. The crosslinkable composition B is left to crosslink at ambient temperature for 1 hour.

In parallel, 6 g of an epoxy resin sold under the tradename WWAS are mixed with 2.4 g of a hardener sold under the tradename WWB4. The crosslinkable composition A obtained is degassed, then 6 g of this crosslinkable composition A are poured onto the crosslinkable composition B in the mould. The crosslinkable compositions A and B are left to crosslink for 24 h.

The upper part of the chip thus obtained is demoulded using compressed air, then pierced to form flow inlet and outlet orifices, using a tool of Dremel type.

### 6.4 Fabrication of a “Cavity Version” Chip

The lower part is fabricated by spin coating of a photosensitive resin on a glass slide and photolithography, under non-actinic conditions. The method used in example 4 can also be carried out.

To do this, a microscope slide with dimensions of 76×26×1.2 mm is used. A compound sold under the reference AZ1512HS by MicroChemicals is deposited by spincoating at a speed of 5000 revolutions per minute and at ambient temperature. The spin-coated slide is then annealed at 100° C. for 2 minutes and insolated using a device sold under the tradename digital SmartPrint, equipped with a 1× objective: 10.2 mW/cm² for 15 seconds at 150 mJ/cm² of power. The spin-coated slide is then developed in an aqueous solution containing 50% by volume of AZ1500 for 45 seconds, and washed in a bath of demineralized water. The assembly obtained is dried and then annealed at 110° C. for 1 min.

The surface of adhesion of the upper part intended to be in contact with the lower part of the chip is sprinkled with acetone for a few seconds and then dried with compressed air. The object or sample to be analysed is placed in the cavity with a magnet of the same format as that used to make the model. The upper part comprising the cavity is then positioned on the lower part. The chip is then closed by simple pressure of the fingers on the upper part.

When it is desired to fabricate other chips as described in examples 1, 2, 3, 4, 5 and 6, the first two steps are not necessary since the moulds of the upper parts have already been fabricated. This considerably reduces the chip fabrication time. Moreover, if it is desired to work with an identical chip several times, the chip is reusable, thereby further reducing the microfabrication times.

To open the chips as fabricated in examples 1, 2, 3, 4, 5 and 6, it is sufficient to disconnect the chip from any fluid inlet and outlet, and to place the chip on a horizontal support, such that the lower part lies on said support (workbench, table, etc.). Then, with both thumbs, a uniform pressure on one of the sides of the chip is applied so that the chamfers make a lever arm. The pressure is maintained until the chip has opened.

1. A reversible microfluidic chip comprising:
at least one lower part and at least one upper part configured to come into contact with said lower part and to close said chip, characterized in that:
said lower part and/or said upper part comprises a microfluidic structure,
said upper part comprises at least a first layer of an epoxide polymer material having a Young's modulus Y₁, and at least a second layer of an epoxide polymer material having a Young's modulus Y₂, said first and second layers being such that:
the Y₁/Y₂ ratio is greater than or equal to 50,
Y₂ is less than or equal to 50 MPa, and
at least one part of said second layer is directly in physical contact with the lower part of said chip when the chip is in the closed configuration.

2. The chip according to claim 1, wherein the Young's modulus Y₁ of the first layer (201) is at least 0.1 GPa.

3. The chip according to claim 1, wherein:
the epoxide polymer material of the first layer is obtained by polyaddition of a crosslinkable composition A comprising at least a first epoxide precursor chosen from the products of the condensation reaction of epichlorohydrin with a polyphenol, at least a second epoxide precursor chosen from diglycidyl ether aliphatic epoxy resins and the products of the condensation reaction of epichlorohydrin with a polyphenol, and at least one hardener, and
the epoxide polymer material of the second layer is obtained by polyaddition of a crosslinkable composition B comprising at least a first epoxide precursor chosen from the products of the condensation reaction of epichlorohydrin with a polyphenol, at least a second epoxide precursor chosen from diglycidyl ether aliphatic epoxy resins and the products of the condensation reaction of epichlorohydrin with a polyphenol, and at least one hardener.

4. The chip according to claim 1, wherein the lower part comprises a rigid material having a Young's modulus Y′₃ such that Y′₃≥Y₁, Y₁ being as defined in claim 1 or 2.

5. The chip according to claim 1, wherein the upper part is a transparent element.

6. The chip according to claim 1, wherein the upper part comprises mechanical means configured for manually opening the microfluidic chip, preferably by the lever effect.

7. The chip according to claim 6, wherein the upper part comprises an upper face which corresponds to the upper face of the chip, and a lower face which corresponds to the face that comes into contact with the lower part of the chip and closes said chip, and in that the mechanical means are chamfers oriented in such a way that the upper face of the upper part of the chip is of larger dimension than the lower face of said upper part.

8. The chip according to claim 1, wherein the lower part of the chip comprises a microfluidic structure.

9. The chip according to claim 8, wherein the upper part of the chip comprises an upper face which corresponds to the upper face of the chip, and a lower face which corresponds to the face that comes into contact with the lower part of the chip and closes said chip, and in that the lower face of the upper part has a planar surface.

10. The chip according to claim 8, wherein the upper part of the chip comprises an upper face which corresponds to the upper face of the chip, and a lower face which corresponds to the face that comes into contact with the lower part of the chip and closes said chip, and in that the upper part comprises an open cavity on the lower face.

11. The chip according to claim 1, wherein the upper part of the chip comprises a microfluidic structure.

12. The chip according to claim 11, wherein the upper part comprises patterns of microfluidic channels having an aspect ratio ranging from 1 to 1600.

13. A method for fabricating a microfluidic chip as defined in claim 1, wherein said method comprises at least the following steps:
i) depositing a crosslinkable composition B capable of forming said epoxide polymer material having a Young's modulus Y₂, in a suitable polymer mould of the upper part,
ii) initiating the crosslinking of the crosslinkable composition B,
iii) depositing a crosslinkable composition A capable of forming said epoxide polymer material having a Young's modulus Y₁, on the crosslinkable composition B before complete crosslinking of the crosslinkable composition B,
iv) leaving the crosslinkable compositions A and B to crosslink for a time sufficient to form respectively the first and second layers of the upper part,
v) demoulding the upper part of the chip comprising the first layer and the second layer, and
vi) optionally assembling the upper part of the chip with a lower part, such that at least one part of said second layer is directly in physical contact with the lower part of said chip.

14. The method according to claim 13, wherein said method also comprises, before step i), a step a) of fabricating the polymer mould of the upper part, comprising at least one substep a₁) of preparing a polymer model of the upper part, and a substep a₂) of moulding with said polymer model.

15. An upper part in a reversible microfluidic chip comprising:
at least a first layer of an epoxide polymer material having a Young's modulus Y₁, and at least a second layer of an epoxide polymer material having a Young's modulus Y₂, said first and second layers being such that:
the Y₁/Y₂ ratio is greater than or equal to 50, and
Y₂ is less than or equal to 50 MPa.

16. An upper part for producing a microfluidic chip as defined in claim 1, wherein said upper part comprises at least a first layer of an epoxide polymer material having a Young's modulus Y₁, and at least a second layer of an epoxide polymer material having a Young's modulus Y₂, said first and second layers being such that:
the Y₁/Y₂ ratio is greater than or equal to 50, and
Y₂ is less than or equal to 50 MPa, and
in that said upper part also comprises mechanical means configured for manually opening said microfluidic chip.

17. A microfluidic chip as defined in claim 1, wherein said microfluidic chip is configured to be applied the any one of the group consisting of medical, biotechnological, biological, analysis, chemical synthesis, and clinical diagnosis applications.

18. The microfluidic chip according to claim 17, wherein said microfluidic chip is configured to be applied in any one of the group consisting of automating biological tests, new generation sequencing, point-of-care diagnostic tests, genetic analysis, capillary electrophoresis, DNA amplification, cell biology, proteomics, diagnostics, drug research, and the synthesis of molecules or nanomaterials, or kinetic studies.
